(19) United States
(12) Patent Application Publication
(10) Pub. No.: US 2021/0009481 A1
(43) Pub. Date: Jan. 14, 2021

(54) METHOD FOR MANUFACTURING ORGANIC LIQUID FERTILIZER

(71) Applicant: DIGESTED ORGANICS LLC, Farmington Hills, MI (US)

(72) Inventors: Robert Levine, Ann Arbor, MI (US); Scott D. Severson, Valparaiso, IN (US)

(21) Appl. No.: 16/924,933

(22) Filed: Jul. 9, 2020

Related U.S. Application Data
(60) Provisional application No. 62/981,575, filed on Feb. 26, 2020.
(60) Provisional application No. 62/871,806, filed on Jul. 9, 2019.

(51) Int. Cl. C05F 3/06; C05C 3/00; C05F 3/02

(52) U.S. Cl. CPC C05F 3/06; C05F 3/02; C05C 3/00

(57) ABSTRACT

Systems and methods for manufacturing an organic liquid fertilizer product are shown. The contemplated systems and methods are configured to treat waste from a natural source in order to produce the organic liquid fertilizer. The liquid organic waste may be derived from an organic source. The liquid organic waste may be pre-treated through an anaerobic digestion process, or it may be treated in a raw form. Advantageously, the systems and methods of the present disclosure may be used to manufacture the organic liquid fertilizer with a sufficiently high nitrogen content, which is usable by plants and crops. The systems and methods are likewise more efficient than known systems and methods to produce such fertilizer products.

### CROSS REFERENCE TO RELATED APPLICATIONS

This application claims the benefit of U.S. Provisional Application Ser. No. 62/981,575, filed on Feb. 26, 2020, and U.S. Provisional Application Ser. No. 62/871,806, filed on Jul. 9, 2019. The entire disclosures of the above applications are hereby incorporated herein by reference.

### FIELD

The present disclosure relates generally to a fertilizer and, more particularly, to a method for manufacturing a liquid fertilizer rich in ammonia nitrogen suitable for use in organic crop production.

### BACKGROUND

Nitrogen is an essential nutrient for plants as a major component of chlorophyll, amino acids, adenosine triphosphate (ATP), and nucleic acids. the building blocks of proteins. Plants absorb nitrogen as either ammonium (NH₄⁺) or nitrate (NO₃⁻), but it is difficult for producers of organic fruits, vegetables, and crops to find cost-effective and allowed fertilizers comprised of these inorganic, plant-available nitrogen sources.

One known type of fertilizer, for example, is Chilean nitrate. This fertilizer is a mined source of inorganic nitrogen. However, Chilean nitrate is expensive and restricted under the National Organic Program (NOP) in the United States to not more than 20% of the total nitrogen budget per cropping cycle.

Another commonly used source of nitrogen for organic farms is manure. However, this fertilizer is typically quite dilute (i.e., less than 1% total nitrogen), contains a large fraction of organic nitrogen that is not immediately plant-available, and is not economical to haul far distances.

Organic fertilizers have also been derived from manure that has been processed. For example, U.S. Pat. No. 10,023,501 to Crabtree describes a method of producing a liquid fertilizer that involves filtering organic waste, acidifying it, and removing water through thermal evaporation. However, this process is expensive due to the high cost of acidification and evaporation, and it is limited to producing a fertilizer with about 4 to 6% total nitrogen.

Accordingly, there is a continuing need for a method of manufacturing an ammonia fertilizer that is suitable for use in organic agriculture, and which is highly concentrated. Desirably, the resultant ammonia fertilizer contains predominantly plant available ammonium, and is economical to produce from natural materials.

### SUMMARY

In concordance with the instant disclosure, a method of manufacturing an organic fertilizer with a high nitrogen content that is usable by plants and crops, which is highly concentrated, contains predominantly plant available ammonium, and is economical to produce from natural materials, has been surprisingly discovered.

In one embodiment, a method for manufacturing a liquid fertilizer includes a step of forming an ammonia-containing gas. The gas is formed by obtaining a liquid organic waste that contains ammoniacal nitrogen, removing suspended solids from the liquid organic waste to obtain a clarified liquid organic waste, heating the clarified liquid organic waste to a temperature above 100° F., and air stripping or steam stripping the clarified liquid organic waste to form the ammonia-containing gas. A next step includes processing the ammonia-containing gas into a condensed liquid, for example, using a condenser as described herein. The liquid fertilizer product is thereby manufactured. The liquid fertilizer product has a nitrogen content greater than 5% by weight relative to the total weight of the liquid fertilizer product is manufactured.

In another embodiment, a system for manufacturing the liquid fertilizer product may include a waste tank. The waste tank may be configured to hold a liquid organic waste that contains ammoniacal nitrogen. As non-limiting examples, the liquid organic waste may be derived from livestock manure, such as dairy manure or pig manure, or food waste. A filter may be in communication with the waste tank. The filter may be configured to remove suspended solids from the organic waste to obtain a clarified liquid organic waste. A heater may be in communication with the filter or another tank to hold the clarified liquid organic waste. The heater may be configured to heat the clarified liquid organic waste to a temperature above 100° F. A stripper may be in communication with the heater. The stripper may be configured to remove dissolved ammonium from the clarified liquid organic waste to provide an ammonia-containing gas. A condenser may be in communication with the stripper. The condenser may be configured to condense the ammonia-containing gas to obtain a liquid fertilizer product. The liquid fertilizer product has a nitrogen content greater than 5% by weight relative to the total weight of the liquid fertilizer product is manufactured.

In yet another embodiment, a method for manufacturing an organic liquid fertilizer product includes the step of forming an ammonia-containing gas. The gas is formed by obtaining a solid or semi-solid organic waste that contains ammoniacal nitrogen, such as chicken manure with a dry matter content of around 20-30%, and drying the organic waste to form an exhaust gas containing ammonia. Next, the method processing the ammonia-containing gas into a condensed liquid, for example, using a condenser as described herein. The organic liquid fertilizer product is thereby manufactured. The liquid fertilizer product has a nitrogen content greater than 5% by weight relative to the total weight of the liquid fertilizer product is manufactured.

In a further embodiment, a system for manufacturing an organic liquid fertilizer includes a waste tank that is configured to hold a solid or semi-solid organic waste containing ammoniacal nitrogen. A dryer is in communication with the waste tank and is configured to dry the solid organic waste to provide ammonia-containing exhaust gas. A condenser is in communication with the gas remover, and is configured to condense the ammonia-containing gas into a condensed liquid to obtain a liquid fertilizer product. The liquid fertilizer product has a nitrogen content greater than 5% by weight relative to the total weight of the liquid fertilizer product is manufactured.

In yet a further embodiment, a liquid fertilizer product derived from manure includes an aqueous solution having a nitrogen content greater than 10% by weight relative to the total weight of the liquid fertilizer product.

### DRAWINGS

The above, as well as other advantages of the present disclosure, will become readily apparent to those skilled in the art from the following detailed description, particularly when considered in the light of the drawings described hereafter.

FIG. 1 is a schematic diagram illustrating a system for manufacturing an organic liquid fertilizer product, according to one embodiment of the present disclosure;

FIG. 2 is a schematic diagram illustrating a method for manufacturing the organic liquid fertilizer product with the system shown in FIG. 1, according to another embodiment of the present disclosure;

FIG. 3 is a schematic diagram illustrating a system for manufacturing an organic liquid fertilizer product, according to a further embodiment of the present disclosure;

FIG. 4 is a schematic diagram illustrating a method for manufacturing the organic liquid fertilizer product with the system shown in FIG. 3, according to yet another embodiment of the present disclosure; and

FIG. 5 is a schematic diagram illustrating a water reclamation system of the system for manufacturing an organic liquid fertilizer product, for use in the systems and methods shown in FIGS. 1-4, according to a further embodiment of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. In respect of the methods disclosed, the order of the steps presented is exemplary in nature, and thus, is not necessary or critical unless otherwise disclosed.

Throughout the description, various dimensions, units of measure, volumes, and quantities are also disclosed; however, it should be appreciated that these features are being provided for purposes of illustrating various examples, and one of ordinary skill in the art may select other suitable dimensions, units of measure, volumes, and quantities within the scope of the instant disclosure.

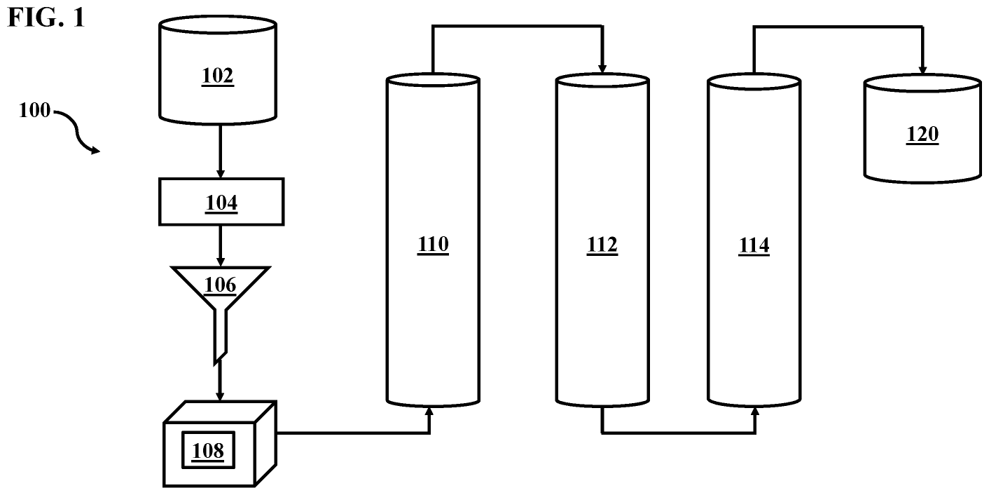

The present disclosure includes systems 100, 300 and methods 200, 400 for manufacturing an organic liquid fertilizer product, as shown in FIGS. 1-5. The contemplated systems 100, 300 and methods 200, 400 are configured to treat waste from a natural source in order to produce the organic liquid fertilizer product. The liquid fertilizer product is, in particular, an aqueous solution containing liquid ammonia derived from the natural source of waste, and may also be referred to herein as “aqueous ammonia” and “ammonium hydroxide.”

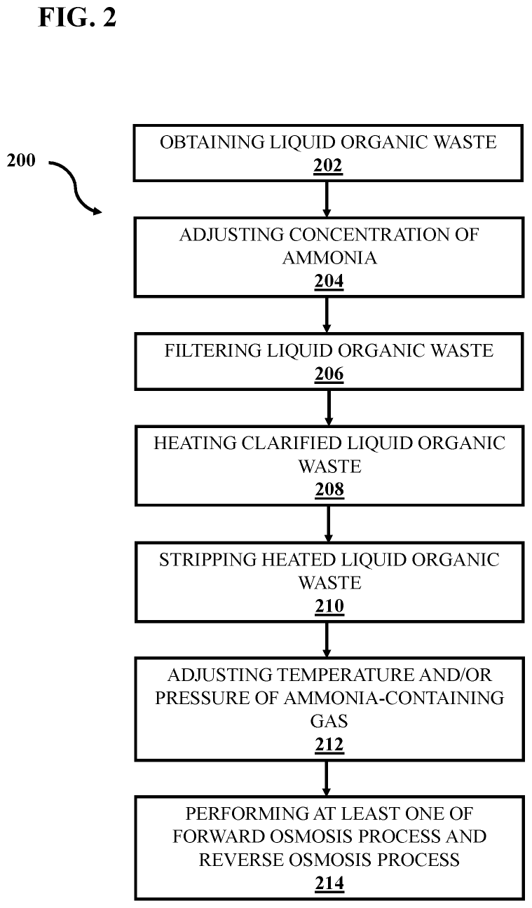

In certain embodiments, as shown in FIGS. 1-2, the waste is a liquid organic waste that may be derived from an organic source. For example, the liquid organic waste may be derived from natural sources including, but not limited to, plant and animal-biproducts, rock powders, seaweed, inoculants, conditioners, dairy product waste, livestock manure (e.g., dairy manure, chicken manure, or swine manure), liquid manure, worm castings, peat, guano, compost, blood meal, bone meal, fish meal, decomposing crop residue, cheese whey, dairy product waste, dry chicken manure, mixed liquor from food and livestock processing facilities, wastewaters from a variety of food processing operations, and combinations thereof. However, it should be appreciated that any natural source that contains ammoniacal nitrogen may be chosen by one skilled in the art.

More particularly, the liquid organic waste may be any aqueous solution that contains a dissolved protein, ammoniacal nitrogen, and other soluble nutrients derived from natural sources. If the organic waste is in a solid or semi-solid form, water may be added to the solid or semi-solid material beforehand to form the fluid mixture. For example, in an embodiment where dry or semi-dry animal manure is utilized, water may be added to form a fluid mixture creating the liquid organic waste. The water thereby creates the fluid mixture of water and suspended plus dissolved solids to form the liquid organic waste.

It should also be appreciated that the liquid organic waste may be pre-treated through an anaerobic digestion or other microbial fermentation process to provide an effluent discharge as the liquid organic waste, or it may be used in a raw form in the system 100 and method 200, as desired.

In one embodiment, as shown in FIG. 1, a system 100 for manufacturing the organic liquid fertilizer product may produce the liquid fertilizer product from a liquid organic waste that contains ammoniacal nitrogen. The system 100 may include a waste tank 102, a concentrator 104, a filter 106, a heater 108, a stripper 110, a condenser 112, a water reclamation system 114, and a collection unit 120, each of which may be placed in selective communication via conducts such as pipes, pumps, motors, valves, and the like, which may be selected by the skilled artisan within the scope of the present disclosure.

The system 100 may also be provided with a controller (not shown) and sensors (not shown) that will permit a user to monitor and regulate an operation of the system 100, as desired. The controller can include a processor and a memory having tangible and non-transitory processor-executable instructions that are embodied thereon. The controller may also be in communication with one or more user interfaces (not shown) such as screens, keyboards, dials, buttons, and the like, which permit the user to interact with and regulate the operation of the system 100 in accordance with the method 200 described further herein. Other suitable types of controllers, sensors, and user interfaces may also be employed, as desired.

The waste tank 102, shown in FIG. 1, may be configured to hold the liquid organic waste. In particular examples, the liquid organic waste may be derived from livestock manure, such as dairy manure or pig manure, or food waste. In a most particular example, the waste tank may include a manure holding tank that receives and maintains, for example, with an optional heating equipment, the liquid organic waste at approximately 104° F. However, one of ordinary skill in the art may also select other suitable sources and holding containers for the liquid organic waste within the scope of the present disclosure.

With continued reference to FIG. 1, the system 100 may have the concentrator 104. The concentrator 104 may be configured to receive and adjust the liquid organic waste from the waste tank 102. In particular, the concentrator 104 may be configured to adjust a concentration of ammonia within the organic liquid waste. Advantageously, the concentrator 104 may reduce an overall volume of liquid, which thereby reduces a total load on the system 100. The reduction in the total load on the system 100 allows the system 100 to be more efficient and economical compared to the system 100 without a concentrator 104.

More particularly, the concentrator 104 may be configured to increase the concentration of ammonia in the liquid organic waste. The concentrator 104 may provide this increase in concentration by either removing liquid devoid of ammonia from the liquid organic waste, or increasing the availability of ammonia in the liquid organic waste by converting organic sources of ammoniacal nitrogen, such as proteins and amino acids, to ammonia.

Suitable mechanisms for the concentrator 104 may include heat treatment in a tank, natural acid hydrolysis through fermentation, fermentation in the presence of ammonia producing organisms, anaerobic digestion, aerobic digestion, forward osmosis, reverse osmosis, evaporation, and combinations thereof. For example, livestock manure when anaerobically digested at between 95° F. and 103° F. for at least 10 days typically has a higher nitrogen content compared to raw untreated manure as some organic nitrogen is converted into ammonium in the liquid waste. A skilled artisan may select other suitable mechanisms for the concentrator 104 within the scope of the present disclosure in order to increase the concentration of ammonia within the liquid organic waste.

Referring still to FIG. 1, the filter 106 may be in communication with the waste tank 102. The filter 106 may be configured to filter the organic waste to obtain an clarified liquid organic waste. Particularly, the filter 106 may be configured to remove suspended solids from the liquid organic waste. The suspended and dissolved solids in the liquid waste may include, but are not limited to nitrogen, phosphorus, potash, secondary nutrients, micro-nutrients and organic matter found in anaerobically digested manure or other agriculturally related organic waste. It should be appreciated that adjusting the temperature of the organic waste may facilitate filtration as well as the dissolution of particulate organic waste into the aqueous solution. Advantageously, the removal of the suspended solids from the liquid organic waste may militate against undesirable clogging in the system 100, in operation.

It should be appreciated that the suspended solids may be removed by the filter 106 via one or more filtration mechanisms including, but not limited to, mechanical screening, microfiltration, ultrafiltration, nanofiltration, reverse osmosis, membrane separation, high-speed mixing (e.g. hydrocyclone), centrifugation, ultrasound and electro-coagulation. It should also be appreciated that a combination of filtration mechanisms may be employed for the filter 106. Natural settling, such as may occur in a lagoon or pond or tank, is also envisioned as a mechanism to create a clarified liquid organic waste with lower amounts of suspended solids. The liquid organic waste may also be electrified or magnetized to crystallize minerals and reduce scaling on process equipment. Suitable types of filtration will be selected by one skilled in the art, for example, depending on conditions and desired processing considerations within the scope of the present disclosure. It should also be understood that, for wastes with very low levels of suspended solids, no filtration may be required.

In certain embodiments, the filter 106 may be capable of removing suspending solids that are larger than from about 1 micron to about 0.02 microns. In certain embodiments, the filter 106 may be a microfilter. The microfilter may be capable of removing suspended solids larger than about 0.1 microns. In further embodiments, the filter 106 may be an ultrafilter. The ultrafilter may be capable of removing solids larger than about 0.02 microns. A skilled artisan may select other suitable filtration methods and acceptable particle sizes, as desired.

It should be understood that a combination of the concentrator 104 and the filter 106 of the system 100 may produce an clarified liquid organic waste. The clarified liquid organic waste has a desirably low suspended solids content and a desirably high concentration of ammonia. Advantageously, the clarified liquid organic waste may not only run more efficiently through a remainder of the system 100, but may also produce an organic liquid fertilizer product, which has a greater concentration of aqueous nitrogen compared to known waste treatment systems.

As further shown in FIG. 1, the system 100 may further include the heater 108. The heater 108 is configured to receive the clarified liquid organic waste. For example, the heater 108 may be in communication with the filter 106. In another example, the heater 108 may be in communication with a holding tank for the clarified liquid organic waste. The heater 108 may further be configured to heat the clarified liquid organic waste to a temperature above 100° F. More particularly, the heater 108 may be configured to heat the clarified liquid organic waste to a temperature above 140° F. Most particularly, the heater 108 may be configured to heat the clarified liquid organic waste to a temperature of at least 165° F. or greater, for example, in order to comply with regulatory requirements and show pathogen kill for manure-derived products. At these temperatures, the heater 108 may be configured to raise the temperature of the clarified liquid organic waste to a predetermined temperature that facilitates the subsequent volatilizing of dissolved ammonia within the clarified liquid organic waste upon introduction to the stripper 110. The heater 108 should be understood to include any suitable heating method known in the art, and a skilled artisan may also select any suitable predetermined temperature to which to heat the clarified liquid organic waste.

In certain embodiments, the stripper 110 may be configured to be selectively pressurized. Advantageously, an adjustable pressure within the stripper 110 may synergistically work with the temperature to further volatilize the dissolved ammonia. In other embodiments, the clarified liquid organic waste may be looped around the stripper 110 and the heater 108 in a feed-and-bleed type of configuration. Other suitable configurations may also be employed, as desired.

The stripper 110 may be in communication with the heater 108, as shown in FIG. 1. In certain embodiments, the heater 108 and the stripper 110 may be provided as a single unitary component or module of the system 100. Advantageously, where the heater 108 and the stripper 110 are a unitary component of the system 100, a temperature and a pressure of the clarified liquid organic waste may be selectively controlled from an initial heating through a gasification of the ammonia. The selective control over certain variables may increase the amount of ammonia captured by the system 100, in the resultant organic fertilizer product.

In particular embodiments, the stripper 110 is configured to remove gases from the clarified liquid organic waste to provide ammonia-containing gas. For example, the stripper 110 may be an air stripper. The air stripper may be configured to blow air over the heated clarified liquid organic waste to remove dissolved ammonium as ammonia gas. In one example, the air stripper may be a column with a top portion and a bottom portion. The clarified liquid organic waste may be pumped into the top portion of the column. Steam may be pumped into the bottom of the column to create counter current extraction. The resulting exhaust gas may be ammonia-containing gas.

The air stripper is advantageous since ammonia has a relatively high vapor pressure and low aqueous solubility. It should be appreciated that the stripper 110 may be configured to allow for a collection of ammonia in a vapor phase coming from the clarified liquid organic waste.

In another example, the air stripper may be a packed tower or tray tower. The packed tower may be configured to be operated with countercurrent flow of the organic waste and air. In yet another example, the organic liquid waste may be put through a steam stripper. The steam stripper may be configured to bubble steam through the clarified liquid organic waste. The steam and any associated heat from the steam may be configured to strip the ammonia from the clarified liquid organic waste.

It should be appreciated that the stripper 110 is specially configured to remove the ammonium present in the clarified liquid organic waste as gaseous ammonia. However, as contemplated by the present disclosure, the stripper 110 may be adapted to other processes or mechanisms for removing ammonia into the gas stream. Non-limiting examples of these other processes or mechanism may include pumping the liquid organic waste through small orifices to create droplets of material with very high surface area to enhance gas-liquid exchange, or modulating the pressure of the liquid organic waste and stripping air to cause preferential liquid to gas exchange. One skilled in the art may also select other suitable ammonia strippers 110, processes, and mechanisms, as desired.

In alternative embodiments, it should be understood that long-term aeration in the waste tank 102 may also be employed instead of, or in addition to, using stripping. For example, this may include a wastewater treatment tank with diffusers in the bottom bubbling air up through the waste tank 102. This process may be used to keep organic waste or clarified liquid organic waste in the tank for days, and capture gas off the top of the sealed tank.

It yet another alternative embodiment, the system 100 may be provided with a second concentrator, but similar to the water reclamation unit 114 described further hereinbelow, as a non-limiting example. The second concentrator will concentrate the clarified liquid organic waste before provision to the stripper 110. In particular, the second concentrator may be disposed between the filter 106 and the stripper 110. For example, the liquid organic waste may be processed via anaerobic digestion, and then filtered using the filter 106 (e.g., ultrafiltration) before being introduced to a forward osmosis unit (with reverse osmosis for draw solution regeneration) or introduced to a reverse osmosis unit (both removing water). Other types of devices and processes for the second concentrator in the system 100 may also be employed by a skilled artisan within the scope of the present disclosure.

With continued reference to FIG. 1, the condenser 112 may be in communication with the stripper 110. The condenser 112 may be configured to process or condense the ammonia-containing gas to form a condensed liquid, and thereby obtain the liquid fertilizer product. For example, the condenser 112 may be configured to selectively adjust at least one of a pressure and a temperature to an interior portion of the condenser 112. In particular, the condenser 112 may selectively adjust at least one of the pressure and the temperature of the ammonia gas to a level below its dew point. Where the pressure and the temperature of the ammonia gas is adjusted below the dew point by the condenser 112, the organic liquid fertilizer product may be formed.

It should be appreciated that the “dew point” is the temperature at which the ammonia gas at constant barometric pressure condenses into liquid ammonia at the same rate at which it evaporates. At temperatures below the dew point, the rate of condensation will be greater than that of evaporation, forming more liquid ammonia. The condensed ammonia liquid is referred to as “dew” when it forms on a solid surface.

As used herein, the terms “condense” and “condenser” are defined to include not only processes and devices for conventional condensation of ammonia from gaseous to liquid states, but also for transferring gaseous ammonia into liquids such as water, for example, through contact with water in a packed bed with high surface area media.

As non-limiting examples, the condenser 112 may be one of a chilled water scrubber and a chilled condenser. However, one skilled in the art may also select other suitable types of the condenser 112 within the scope of the present disclosure.

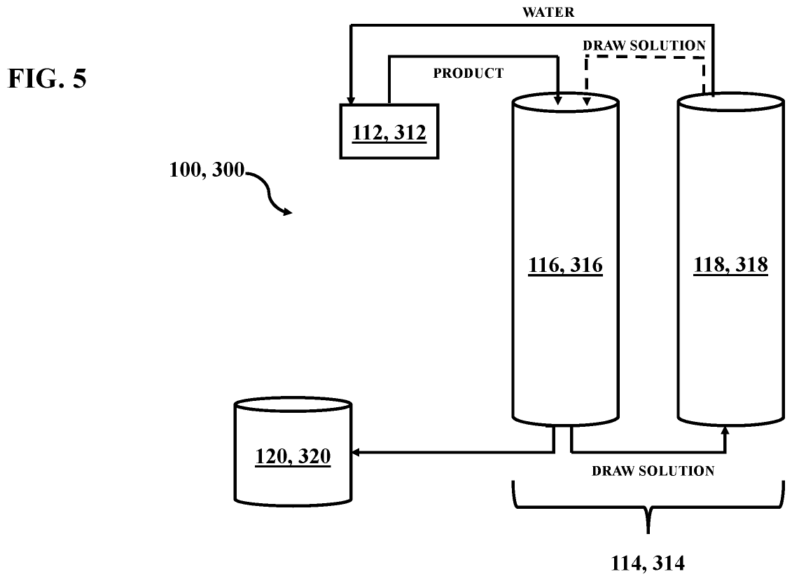

In particular, after the ammonia is stripped from the liquid organic waste, the ammonia and water mixture is condensed into the liquid form. In a most particular embodiment, the ammonia containing gas is chilled by passing through a packed bed tower maintained at 35-70° F. The ammonia is transferred into the liquid phase and is carried out of the tower by a recirculating flow of cold water. A portion of the recirculating cold water, which contains ammonium, is processed to produce the fertilizer product containing greater than about 10% nitrogen by weight relative to the total weight of the liquid fertilizer product. Higher concentrations of ammonia are obtainable by varying the operation of the condenser and through use of the water reclamation system 114 as described further herein and shown in FIG. 5. Multiple condensers may be used. The organic liquid fertilizer product may also then be diluted or further concentrated prior to shipping, if desired.

In another embodiment, the air may be cooled by chilling condensing coils to in order to create the ammonia-water condensate. Without being bound by any particular theory, it is believed that the stripped gas may be cooled to a temperature below its dew point, which causes liquid to condense and collect on the surface of the chilled condenser.

In certain embodiments, the condenser 112 may be a wet ammonia scrubber. The wet ammonia scrubber may be a packed bed wet ammonia scrubber, as a non-limiting example. The wet ammonia scrubber may be a column configured to receive the ammonia-containing gas, from the stripper 110, near a bottom portion of the column. The column may have a packed bed disposed above the bottom portion of the column. The packed bed may be configured to receive the ammonia-containing gas, while a scrubbing liquid may simultaneously enter the column through a top portion of the column.

In yet another embodiment, the wet ammonia scrubber may be in communication with an organic-certified acid source that is configured to supply an organic-certified acid to the wet ammonia scrubber. As a non-limiting example, the organic-certified acid may be citric acid. It should be understood that the addition of the organic-certified acid to the scrubber water may enhance the transfer of gaseous ammonia into water soluble ammonium due to a change in pH of the scrubber water associated with the addition. Other suitable types, amounts, and pH adjustments associated with the organic-certified acid may also be employed, as desired.

It should also be appreciated that the system 100 may contain two or more of the condenser 112. For example, a first one of the condensers 112 may be configured condense the moisture, generally, from the ammonia-containing gas at a first temperature and pressure. A second one of the condensers 112 may be configured to condense the ammonia from the remaining gas at a second temperature and pressure. A skilled artisan may select a suitable number of condensers 112 and suitable temperatures for any of the condensers 112, as desired.

In yet another embodiment, it should be understood that Pressure Swing Adsorption (PSA) may be employed instead of, or in addition to, the condenser 112. In particular, PSA is contemplated as a further method to capture the ammonia in the stripping gas stream instead of condensation of the ammonia gas and water vapor through chilling.

The system 100 may further include a water reclamation system 114, which may be in communication with the at least one condenser 112 as shown in FIG. 1. The water reclamation system 114 may be configured to receive the organic liquid fertilizer product from the condenser 112. The water reclamation system 114 may be configured to remove water from the organic liquid fertilizer product, and thus, increase an ammonia concentration within the organic liquid fertilizer product.

It should be appreciated that the water reclamation system 114 of the present disclosure may be configured to perform at least one of a reverse osmosis process and a forward osmosis process. Reverse osmosis is a water purification process that uses a partially permeable membrane to remove ions, unwanted molecules and larger particles from water. Forward osmosis is an osmotic process that, like reverse osmosis, uses a semi-permeable membrane to separate water from dissolved solutes. The driving force for this separation is an osmotic pressure gradient, such that a “draw” solution of high concentration (relative to that of the feed solution), is used to induce a net flow of water through the membrane into the draw solution, thus effectively separating the water from the solutes. In reverse osmosis, an applied pressure is used to overcome osmotic pressure.

The water reclamation system 114 of the present disclosure may optionally perform a combination of the reverse osmosis process and the forward osmosis process. It should be appreciated that water reclaimed by the water reclamation system 114 may then be recycled back into the system 100. For example, the water may be pumped back into the condenser 112. A skilled artisan may utilize the reclaimed clean water in any suitable manner, as desired.

In one particular embodiment, as shown in FIG. 5, the water reclamation system 114 may be configured to with both forward osmosis and the reverse osmosis processes. In this case, a forward osmosis unit 116 dewaters the organic liquid fertilizer product from the condenser 112 by putting water into the draw solution. A reverse osmosis unit 118 processes the draw solution to remove the water. It should also be appreciated that the forward osmosis process may be employed with a multitude of different strategies to regenerate the draw solution. Advantageously, water may be removed from organic liquid fertilizer product effluent being discharged from the condenser 112 through either forward osmosis or reverse osmosis, and in certain examples the condenser effluent may be provide directly into the reverse osmosis process.

The forward osmosis unit 116 may have a semi-permeable, thin film membrane (not shown) disposed therein. In operation, the forward osmosis unit 116 may be configured to receive the organic liquid fertilizer product on a first side of the membrane. A draw solution or osmotic agent may be disposed on an opposite side of the membrane. The draw solution may be a salt solution, for example. Water may selectively pass through the membrane, thereby, increasing the concentration of ammonia remaining on the first side of the membrane. The forward osmosis unit 116 may result in a more concentrated organic liquid fertilizer product. The draw solution, which becomes diluted with water, can be regenerated through use of reverse osmosis or other means known to those skilled in the art.

The reverse osmosis 118 unit may also have a semi-permeable, thin film membrane (not shown) disposed therein. Water may selectively pass through the membrane, resulting in an increase in the ammonia concentration of the organic liquid fertilizer product. The reverse osmosis unit 118 may produce the liquid fertilizer product and clean water. It should be appreciated that the clean water reclaimed during this process may then be recycled into the system 100. Additionally, the forward osmosis unit 116 and the reverse osmosis unit 118 may be repeatedly used by cycling the reclaimed water therethrough until the desired concentration of ammonia is reached in the liquid organic fertilizer product.

In an alternate embodiment, the water reclamation system 114 may instead be provided in the form of a purely thermal process instead of, or in addition to, use of forward osmosis and reverse osmosis processes. For example, the water reclamation system 114 may involve the use of a rectifier to evaporate and condense the ammonia in the liquid organic fertilizer product.

Where the rectifier is employed, the ammonia-water solution passes into a compressor where it is compressed, and the compressed solution then passes through a first heat exchanger. The heat exchanger recovers heat from water leaving a generator and transfers it to the ammonia-water solution entering the generator. More particularly, the ammonia-water solution then passes into the generator where it is heated in the rectifier to remove ammonia from the solution as gas, and to remove water vapor from the ammonia gas. The ammonia gas then is cooled, to further condense water vapor from the gas. The ammonia gas then passes into a condenser, where it is condensed into liquid ammonia, which is then recovered. One skilled in the art may also select suitable types of thermal processes and rectifiers within the scope of the present disclosure.

With renewed reference to FIGS. 1 and 5, the collection unit 120 may be in communication with the water reclamation system 114. More particularly, the collection unit 120 may be in communication with the forward osmosis unit 116 or reverse osmosis unit 118. The collection unit 120 may receive the liquid organic fertilizer product for storage or transport until a desired end use.

In the scenario of passing the ammonia-gas through a water scrubber tower, it should be appreciated that at least one of forward osmosis and reverse osmosis may also be employed to concentrate that liquid fertilizer product. Likewise, it should be appreciated that the present system 100 and method 200 may employ the use of a rectifier (i.e., a boiler-condenser) for the thermal concentration.

It should be appreciated that the system 100 is configured to treat liquid organic waste to form the liquid fertilizer product, which is likewise organic in nature. Desirably, the resultant organic liquid fertilizer product may be an ammonia and water solution, where the concentration of nitrogen in water is greater than about 5% by weight relative to the total weight of the liquid fertilizer product, and more particularly from about 10% to about 23% by weight relative to the total weight of the liquid fertilizer product. In particular, the concentration of nitrogen may be adjusted to be from about 13% to about 23% by weight relative to the total weight of the liquid fertilizer product, and most particularly is about 13% by weight relative to the total weight of the liquid fertilizer product. It should also be appreciated that a concentration of nitrogen greater than 10% by weight relative to the total weight of the liquid fertilizer product may be preferred.

It should be appreciated that though the liquid fertilizer product may be combined with additional ingredients to manufacture additional fertilizer products. The additional ingredients may advantageously be natural or organic. For example, the liquid fertilizer product may be combined with other fertilizers, nitrate, Chilean nitrate, microbial products, bacteria, fungus, yeast, mushrooms, minerals, vitamins, guano, dried and powdered blood, ground bone, crushed shells, finely pulverized fish, phosphate rock, coffee grounds, and seaweed. The additional ingredients may be selected by a skilled artisan based on any requirements for a selected end use for the additional fertilizer products.

Referring now to FIG. 2, the method 200 for manufacturing the organic liquid fertilizer product may produce the liquid fertilizer product from a liquid organic waste. In particular, the method 200 may utilize the system 100, as described hereinabove, to form the liquid fertilizer product. Although the method 200 is described primarily herein with reference to the associated system 100, for purpose of simplicity, it should be appreciated that other types of systems for executing the method 200 may also be employed within the scope of the present disclosure.

The method 200 may involve a first step 202 of obtaining the liquid organic waste that contains ammoniacal nitrogen. As described hereinabove, the liquid organic waste may desirably be from dairy manure, swine manure, or food waste, although other types of liquid organic waste may also be used. Additionally, the liquid organic waste may also be a dry or semi-dry organic waste, such as chicken manure, that has been mixed with water. The organic liquid waste may be placed in the waste tank 102.

A second step 204 in the method 200 may include an adjusting of the concentration of ammonia in the liquid organic waste. More particularly, the second step 204 may include increasing the concentration ammonia. The second step may involve pumping the liquid organic waste from the waste tank 102 to the concentrator 104. In the concentrator 104, the second step 204 may include at least one of a forward osmosis process, a reverse osmosis process, an anaerobic digestion process, an evaporation process, and a fermentation process. Other suitable processes, or combinations of processes, for adjusting the concentration of the ammonia in the liquid organic waste are also contemplated and considered to be within the scope of the present disclosure.

It should be appreciated that the concentration of ammonia may be increased by one of two methods. A first method may include a decreasing of the amount of water present in the liquid organic waste, and thus, increasing the concentration of ammonia. A second method may include an increasing of the amount of ammonia within the liquid organic waste, thereby, increasing the ammonia concentration. A skilled artisan may select other suitable methods of increasing the concentration of ammonia for the second step 204, as desired.

A third step 206 in the method 200 may include a filtering of the liquid organic waste to obtain the clarified liquid organic waste. In particular, the liquid organic waste may be pumped from the concentrator 104 through the filter 106. The third step 206 may include one of microfiltration and ultrafiltration, as selected by the user. Microfiltration is a type of filtration process where a fluid is passed through a membrane or filter to separate microorganisms and suspended particles from waste liquid. Ultrafiltration is a variety of membrane filtration utilizing membranes with smaller pores than a microfilter. The third step 206 includes removing suspending solids that are larger than about 1 micron, more particularly larger than about 0.1 microns, and most particularly larger than about 0.02 microns. Although these particle sizes may be preferred, it should be appreciated that other suitable filtration particle sizes can also be selected within the scope of the disclosure.

The method 200 may include a fourth step 208 of heating the clarified liquid organic waste to a temperature above 100° F. In particular, the liquid organic waste may be heated to a temperature above 140° F. The clarified liquid organic waste may be heated in the heater 108.

It should be appreciated that the heating step 208 is configured to volatilize the ammonia within the liquid organic waste inside the stripper. It has been surprisingly found that in the fourth step 208, and ultimately, the volatilization of ammonia may be performed without an addition of an acid or a base. An optional step of adding a base to the clarified liquid organic waste may be performed. However, where this step is performed, a resultant product may not qualify for approval as an organic fertilizer. Accordingly, where the liquid fertilizer product is desired to be considered organic, the fourth step 208 is performed without an adjustment of a pH of the clarified liquid organic waste.

Additionally, the fourth step 208 may include a selective adjusting of a pressure of the clarified liquid organic waste in the stripper. It should be appreciated that the pressure is adjusted in the stripper and not in the heater. Advantageously, the selective pressure adjustment may further volatize the ammonia in the clarified liquid organic waste.

The method 200 may have a fifth step 210 of stripping the heated clarified liquid organic waste to form the ammonia-containing gas. The stripping step 210 may be performed by the stripper 110. The stripping step 210 may include the use of the air stripper or the steam stripper, or a combination thereof, as described hereinabove. The stripping step 210 may include blowing air or steam over the heated clarified liquid organic waste to obtain the ammonia-containing gas.

A sixth step 212 in the method 200 may include an adjusting of at least one of a temperature of the ammonia-containing gas and a pressure of the ammonia-containing gas to below its dew point to condense the ammonia-containing gas. The sixth step 212 may be performed by the condenser 112. The adjustment of the temperature may include the use of a chilled water scrubber and a chilled condenser. The result of the sixth step 212 is the liquid fertilizer product.

The method 200 may include a seventh step 214 of performing at least one of the forward osmosis process and the reverse osmosis process on the liquid fertilizer product. The seventh step 214 may be performed with the water reclamation system 114, as described hereinabove. In other examples, the seventh step 214 may involve pure thermal processes such as the use of a thermal rectifier, as described hereinabove, in lieu of or in addition to the osmosis processes.

Most particularly, the seventh step 214 may include a step of performing forward osmosis on the liquid fertilizer product in the forward osmosis unit 116 to dewater the organic liquid fertilizer from the condenser 112 by putting water into the draw solution. Then, the method 200 may include a step of removing excess water from the draw solution with reverse osmosis in the reverse osmosis unit 118.

It should be appreciated that the seventh step 214 may include only the reverse osmosis process, in some examples. However, the inclusion of the forward osmosis process in other examples is believed to advantageously reduce the amount of water in the organic fertilizer product with less membrane fouling than high pressure reverse osmosis, and thus may be preferred.

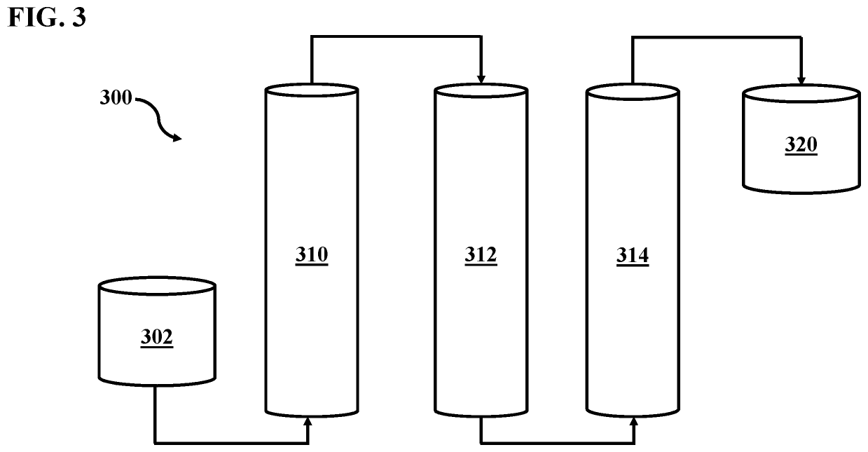

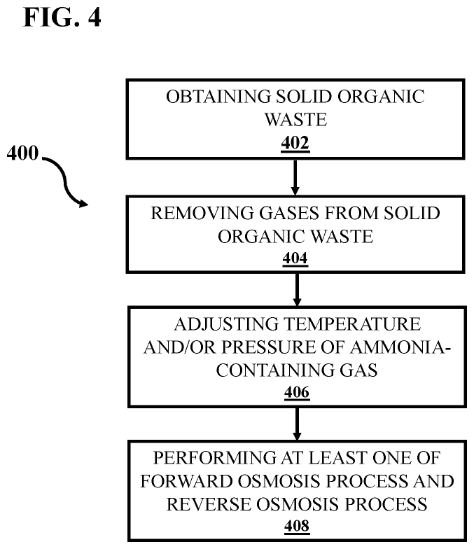

With reference to FIGS. 3 and 4, a system 300 and method 400, according to another embodiment of the present disclosure, for manufacturing the organic liquid fertilizer product from a solid organic waste is shown. As used herein, the term “solid organic waste” is defined to include both completely solid and semi-solid wastes including, for example, wet chicken manure which is known to be about 20-30% dry matter and 70-80% moisture. Like or related structure from FIGS. 1 and 2, which were identified in 100- and 200-series, respectively, are identified in FIGS. 3 and 4 in 300- and 400-series, respectively, for purpose of clarity.

As shown in FIG. 3, the system 300 may include a waste tank 302, a gas remover 310, a condenser 312, a water reclamation system 314, and a collection unit 320, each of which may be placed in selective communication via conducts such as pipes, pumps, motors, valves, and the like, which may be selected by the skilled artisan within the scope of the present disclosure. As with the system 100, the system 300 may also be provided with a controller (not shown) and sensors (not shown) that will permit a user to monitor and regulate an operation of the system 300, as described further herein.

The waste tank 302 may be configured to hold a solid organic waste that contains ammoniacal nitrogen. The system 300 may be particularly suited for treatment of solid organic wastes. A particular non-limiting example may be chicken manure; however, one skilled in the art may also select other suitable types of solid organic waste for treatment by the system 300 and the method 400, as desired.

The gas remover 310 is in communication with the waste tank 302. The gas remover 310 is configured to remove gases from the solid organic waste to provide ammonia-containing gas. In one embodiment, the gas remover 310 may be a dryer. The dryer may be configured to apply heat to the solid waste. The heat will cause the ammonia to be released as ammonia-containing gas. Dried solids may be left over in the dryer. Advantageously, the dried solids may be utilized in an additional dry fertilizer product.

In alternative embodiments, for example as shown in FIG. 2, the gas remover 310 may be replaced with an air stripper. The air stripper may be configured to apply air to the solid organic waste. The blown air may be configured to produce ammonia rich exhaust gases.

The system 300 may further include the condenser 312. The condenser 312 may be in communication with the gas remover 310. The condenser 312 may be configured to process or condense the ammonia-containing gas from the gas remover 310 to form a condensed liquid, and thereby obtain a liquid fertilizer product. The condenser 312 may be configured to selectively adjust at least one of a pressure and a temperature to an interior portion of the condenser 312. In particular, the condenser 312 may selectively adjust at least one of the pressure and the temperature of the ammonia gas to a level below a dew point of the ammonia. Where the pressure and the temperature of the ammonia gas is adjusted below the dew point by the condenser 312, the organic liquid fertilizer product may be formed as a condensate.

As non-limiting examples, the condenser 312 may be one of a chilled water scrubber and a chilled condenser, as described herein. However, a skilled artisan may select other suitable types of apparatus for the condenser 312, as desired.

In certain embodiments, the condenser 312 may be a wet ammonia scrubber. The wet ammonia scrubber may be a packed bed wet ammonia scrubber, as a non-limiting example. The wet ammonia scrubber may be a column configured to receive the ammonia-containing gas, for example, from the gas remover 310, near a bottom portion of the column. The column may have a packed bed disposed above the bottom portion of the column. The packed bed may be configured to receive the ammonia-containing gas, while a scrubbing liquid may simultaneously enter the column through a top portion of the column.

It should also be appreciated that the system 300 may contain two or more of the condensers 312. For example, a first one of the condensers 312 may be configured condense the moisture, generally, from the ammonia-containing gas at a first temperature. A second one of the condensers 312 may be configured to condense the ammonia from the remaining gas at a second temperature. A skilled artisan may select a suitable number of condensers 312 and a suitable temperature for any of the condensers 306, as desired.

As described hereinabove, the system 300 may further include the water reclamation system 314. The water reclamation system 314 may be configured to receive the organic liquid fertilizer product from the condenser 312. The water reclamation system 314 may be configured to remove water from the organic liquid fertilizer product, and thus, increase an ammonia concentration within the organic liquid fertilizer product.

As shown in FIG. 5, the water reclamation system 314 may be configured to perform at least one of a reverse osmosis process and a forward osmosis process. The water reclamation system 314 may optionally perform a combination of the reverse osmosis process and the forward osmosis process. It should be appreciated that water reclaimed by the water reclamation system 314 may be recycled back into the system 300. For example, the water may be pumped back into the condenser 312. A skilled artisan may utilize the reclaimed clean water in any suitable manner, as desired.

In one particular embodiment, also shown in FIG. 5, the water reclamation system 314 may be configured to perform a loop of the forward osmosis process and the reverse osmosis process. The water reclamation system 314 may have a forward osmosis unit 316, which is configured to receive the organic liquid fertilizer product from the condenser 312. The forward osmosis unit 316 may have a semi-permeable, thin film membrane disposed therein. The forward osmosis unit 316 may be configured to receive the organic liquid fertilizer product on a first side of the membrane. A draw solution or osmotic agent may be disposed on an opposite side of the membrane. The draw solution may be a salt solution. Water may selectively pass through the membrane, thereby, increasing the concentration of ammonia in the first side of the membrane. The forward osmosis unit 316 may result in a more concentrated organic liquid fertilizer product.

A reverse osmosis unit 318 may receive the organic liquid fertilizer product from the condenser 312. The reverse osmosis 318 unit may have a semi-permeable, thin film membrane disposed therein. Water may selectively pass through the membrane, resulting in an increase in the ammonia concentration of the organic liquid fertilizer product. It should be appreciated that the clean water reclaimed during this process may be recycled into the system 300. Additionally, the forward osmosis unit 316 and the reverse osmosis unit 318 may be repeatedly used, for example, in a continuous loop, until the desired concentration of ammonia is reached in the liquid organic fertilizer product.

The collection unit 320 of the system 300 may be in fluid communication with the water reclamation system 314. More particularly, the collection unit 320 may be in communication with the reverse osmosis unit 318. The collection unit 320 may receive the liquid organic fertilizer product for storage until a desired end use.

It should be appreciated that the system 300 is configured to treat liquid organic waste to form the organic liquid fertilizer product. The organic liquid fertilizer product may be an ammonia and water solution, where the concentration of nitrogen in water is greater than about 5% by weight relative to the total weight of the liquid fertilizer product, and more particularly from about 5% to about 23% by weight relative to the total weight of the liquid fertilizer product. In particular, the concentration of nitrogen may be adjusted to be from about 13% to about 23% by weight relative to the total weight of the liquid fertilizer product, and most particularly from about 13% by weight relative to the total weight of the liquid fertilizer product. It should also be appreciated that a concentration of nitrogen greater than 10% by weight relative to the total weight of the liquid fertilizer product may be preferred.

It should be appreciated that though the liquid fertilizer product may be combined with at least one additional ingredient to manufacture additional fertilizer products. The additional ingredients may advantageously be natural or organic. For example, the liquid fertilizer product may be combined with other fertilizers, nitrate, Chilean nitrate, microbial products, bacteria, fungus, yeast, mushrooms, minerals, vitamins, guano, dried and powdered blood, ground bone, crushed shells, finely pulverized fish, phosphate rock, coffee grounds, and seaweed, or any combination thereof. The additional ingredients and suitable concentrations of the same may be selected by a skilled artisan based on predetermined requirements, for example, a known end use for the additional fertilizer products, as desired.

In another embodiment, as shown in FIG. 4, a method 400 for manufacturing the organic liquid fertilizer product may generate the liquid fertilizer product from a solid organic waste. In particular, the method 400 may utilize the system 300, as described hereinabove, to form the liquid fertilizer product. Although the method 400 is described primarily herein with reference to the associated system 300, for purpose of simplicity, it should be appreciated that other types of systems for executing the method 400 may also be employed within the scope of the present disclosure.

The method 400 may have a first step 402 of obtaining the solid organic waste that contains ammoniacal nitrogen. As described hereinabove, the sold organic waste may desirably be obtained from or as chicken manure. The organic liquid waste may be placed in the waste tank 302.

The method 400 may have a second step 404 of removing gases from the solid organic waste to form the ammonia-containing gas. The solid clarified liquid organic waste may be heated in the gas remover 310, which as non-limiting examples, may be the dryer or the stripper, as described hereinabove. It should be appreciated that the removing step 404 is configured to volatilize the ammonia within the solid organic waste. Importantly, the second step 404, and ultimately, the volatilization of ammonia may be performed without an addition of an acid or a base.

A third step 406 in the method 400 may be adjusting at least one of a temperature of the ammonia-containing gas and a pressure of the ammonia-containing gas to below the dew point to condense the ammonia-containing gas. The third step 406 may be performed by the condenser 312. The adjustment of the temperature may include the use of a chilled water scrubber and a chilled condenser. The result of the third step 405 is the liquid fertilizer product.

The method 400 may include a fourth step 408 of performing at least one of the forward osmosis process and the reverse osmosis process on the liquid fertilizer product. The fourth step 408 may be performed with the water reclamation system 314, as described hereinabove.

More particularly, the fourth step 408 may include performing forward osmosis on the liquid fertilizer product in the forward osmosis unit 316 and removing excess water with the liquid fertilizer product with reverse osmosis in the reverse osmosis unit 318 to provide the organic liquid fertilizer product and clean water.

It should be appreciated that the fourth step 408 may include only the reverse osmosis process, which is effective at removing excess water as described hereinabove.

### EXAMPLES

The systems 100, 300 and the methods 200, 400 are expected to perform in a scaled or commercial environment as follows.

### Example 1

Each day, 100,000 gallons of raw dairy manure at a commercial dairy farm will be added to the waste tank 102. The manure will be pumped in a continuous fashion through the concentrator 104, namely, a heated anaerobic digester with an average hydraulic retention time of about 20 days. This process will produce biogas, while also increasing the nitrogen content of the material. The effluent of the anaerobic digester will be pumped through a screw-press to remove large fibers.

The liquid from the screw press (about 90,000 gallons) will be pumped to a filter 106, namely, an ultrafiltration unit to create clarified liquid organic waste (about 67,500 gallons) with 15 lb/1,000 gallons nitrogen from ammonia (equivalent to about 1,804 mg/L nitrogen from ammonia).

The temperature of the clarified liquid organic waste will be raised to 165° F. in the heater 108 and then pumped into the top of the stripper 110, namely, a stripping column. Air will be blown into the bottom of the column and ammonia will be removed from the clarified liquid organic waste in a gaseous form.

The gaseous ammonia will be pumped into the bottom of the condenser 112, namely a chilled scrubber tower, to condense. Ammonia will be captured in cold water recirculating in the chilled scrubber tower. A portion of the recirculating cold water will be processed to remove water and concentrate the ammonium hydroxide present, for example, with the water reclamation system 114. The liberated water will be recycled to the scrubbing tower. The final fertilizer product will be stored in the collection unit 120 for later sale. After accounting for losses and efficiencies of stripping, approximately 7,000 lbs. (or 834 gallons) of liquid fertilizer containing 13% nitrogen by total weight of the liquid fertilizer product will be produced each day.

### Example 2

Each day, 100,000 gallons of raw liquid dairy manure will be added to the waste tank 102. The manure will be pumped in a continuous fashion through the concentrator 104, namely, a heated anaerobic digester with an average hydraulic retention time of about 20 days. This process will produce biogas, while also increasing the nitrogen content of the material. The effluent of the anaerobic digester will be pumped through a screw-press to remove large fibers.

The liquid from the screw press (about 90,000 gallons) will be pumped to the filter 106, namely, an ultrafiltration unit to create clarified liquid organic waste (about 67,500 gallon) with 15 lb/1,000 gallons nitrogen from ammonia (equivalent to about 1,804 mg/L nitrogen from ammonia). The clarified liquid organic waste will be dewatered using the concentrator 104. The concentrator 104 will perform forward osmosis, which will result in 50,625 gallons of liberated clean water and 16,875 gallons of concentrate that will contain 60 lb/1000 gallons nitrogen from ammonia. The temperature of the concentrate will be raised to 165° F. in the heater 108 and then will be pumped into the stripper 110. More particularly, the concentrate will be pumped to a top of a stripping column. Air will be blown into the bottom of the column and ammonia will be removed from the concentrate as a gas.

The gaseous ammonia will be pumped into the condenser 112. More particularly, the gaseous ammonia will be pumped to a bottom of the chilled scrubber tower.

Ammonia will be captured in the cold water recirculating in the chilled scrubber tower. A portion of the recirculating cold water will be processed with the water reclamation system 114 to remove water and concentrate the ammonium hydroxide present. After accounting for losses and efficiencies of stripping, approximately 7,000 lbs. (or 834 gallons) of liquid fertilizer product containing 13% nitrogen by total weight of the liquid fertilizer product will be produced each day.

Advantageously, the systems 100, 300 and the methods 200, 400 of the present disclosure may be used to manufacture the liquid fertilizer that is both organic and has a high nitrogen content that is usable by plants and crops. The systems 100, 300 and the methods 200, 400 are likewise more efficient than known systems and methods to produce such fertilizer products, and preferably are effective without requiring the addition of bases or acids to adjust pH of effluents and waste solids employed to produce the organic liquid fertilizer.

While certain representative embodiments and details have been shown for purposes of illustrating the invention, it will be apparent to those skilled in the art that various changes may be made without departing from the scope of the disclosure, which is further described in the following appended claims.

What is claimed is:

1. A method for manufacturing a liquid fertilizer product, comprising the steps of:
forming an ammonia-containing gas by
obtaining a liquid organic waste that contains ammoniacal nitrogen,
removing suspended solids from the liquid organic waste to obtain a clarified liquid organic waste,
heating the clarified liquid organic waste to a temperature above 100° F., and air stripping or steam stripping the clarified liquid organic waste to form the ammonia-containing gas; and
processing the ammonia-containing gas into a condensed liquid,
whereby the liquid fertilizer product having a nitrogen content greater than 5% by weight relative to the total weight of the liquid fertilizer product is manufactured.

2. The method of claim 1, further comprising the step of adjusting a concentration of ammoniacal nitrogen in the organic liquid waste before the filtering step.

3. The method of claim 2, wherein the step of adjusting the concentration of ammoniacal nitrogen includes at least one of a microfiltration process, ultrafiltration process, forward osmosis process, a reverse osmosis process, an anaerobic digestion process, an evaporation process, and a microbial fermentation process.

4. The method of claim 1, wherein the step of removing suspended solids includes at least one of microfiltration, ultrafiltration, and combinations thereof.

5. The method of claim 1, wherein the liquid organic waste is one of livestock manure and food waste, which is provided one of raw and anaerobically digested.

6. The method of claim 1, wherein a pH of the clarified liquid organic waste is not adjusted by the addition of an acid or a base before the step air stripping or steam stripping the clarified liquid organic waste.

7. The method of claim 1, wherein the step of removing suspended solids from the liquid organic waste includes removing suspended solids that are larger than about 0.1 micron.

8. The method of claim 1, wherein the step of removing suspended solids from the liquid organic waste includes removing suspended solids that are larger than about 0.02 microns.

9. The method of claim 1, wherein the step of heating the clarified liquid organic waste includes heating the clarified liquid organic waste to a temperature of at least 140° F.

10. The method of claim 1, further comprising the steps of performing at least one of a forward osmosis process, a reverse osmosis process, and a rectifier process on the condensed liquid to remove water and increase the concentration of aqueous ammonia in the liquid fertilizer product.

11. The method of claim 1, wherein the liquid fertilizer product is an ammonia water mixture having an ammonia concentration greater than 10% by weight relative to the total weight of the liquid fertilizer product.

12. The method of claim 1, wherein the step of adjusting at least one of the temperature of the ammonia-containing gas and the pressure of the ammonia-containing gas includes a step of passing the ammonia-containing gas through a packed bed with chilled water.

13. A liquid fertilizer product manufactured according to the method of claim 1.

14. A system for manufacturing a liquid fertilizer product, comprising:
a waste tank configured to hold a liquid organic waste that contains ammoniacal nitrogen;
a filter in communication with the waste tank, and configured to filter the organic waste to obtain an clarified liquid organic waste;
a heater receiving the clarified liquid organic waste, and configured to heat the clarified liquid organic waste to a temperature above 100° F.;
a stripper receiving the clarified liquid organic waste that has been heated, and configured to remove gases from the clarified liquid organic waste to provide ammonia-containing gas; and
a condenser, in communication with the stripper, and configured to condense the ammonia-containing gas to obtain the liquid fertilizer product having a nitrogen content greater than 5% by weight relative to the total weight of the liquid fertilizer product.

15. The system of claim 14, further comprising a concentrator unit, which is configured to receive the liquid organic waste from the waste tank and adjust an ammonia concentration of the clarified liquid organic waste, the concentrator in further communication with the filter.

16. The system of claim 14, further comprising a water reclamation system, which is configured to receive the organic liquid fertilizer product from the condenser, the water reclamation system configured to perform at least one of forward osmosis, reverse osmosis, and thermal rectification on the liquid fertilizer product to remove excess water and increase the concentration of ammonium.

17. The system of claim 14, wherein the filter is one of an ultrafilter and a microfilter.

18. A method for manufacturing a liquid fertilizer product, the method comprising the steps of:
forming an ammonia-containing gas by
obtaining a solid organic waste that contains ammoniacal nitrogen, and
removing gases from the solid organic waste to form the ammonia-containing gas; and
processing the ammonia-containing gas into a condensed liquid,
whereby the liquid fertilizer product is manufactured having a nitrogen content greater than 5% by weight relative to the total weight of the liquid fertilizer product.

19. A liquid fertilizer product manufactured according to the method of claim 18.

20. A system for manufacturing a liquid fertilizer product, comprising:
a waste tank configured to hold a solid organic waste that contains ammoniacal nitrogen;
a gas remover in communication with the waste tank, and configured to remove gases from the solid organic waste to provide ammonia-containing gas; and
a condenser, in communication with the gas remover, and configured to condense the ammonia-containing gas to obtain a liquid fertilizer product having a nitrogen content greater than 5% by weight relative to the total weight of the liquid fertilizer product.

21. The system of claim 20, wherein the gas remover is one of a dryer and an air stripper.

22. A liquid fertilizer product derived from manure, comprising an aqueous solution having a nitrogen content greater than 10% by weight relative to the total weight of the liquid fertilizer product.

23. The liquid fertilizer product derived from manure of claim 22, further comprising at least one additional ingredient selected from the group consisting of an other fertilizer, nitrate, Chilean nitrate, microbial products, bacteria, fungus, yeast, mushrooms, minerals, vitamins, guano, dried and powdered blood, ground bone, crushed shells, finely pulverized fish, phosphate rock, coffee grounds, seaweed, and any combination thereof.
